(19) United States
(12) Patent Application Publication
(10) Pub. No.: US 2008/0252832 A1
(43) Pub. Date: Oct. 16, 2008

(54) Image Display Apparatus

(75) Inventors: Armanda Cinderella Nieuwkerk, Grashoek (NL); Hendrik De Koning, Eindhoven (NL); Dirk Jan Broer, Eindhoven (NL); Cornelis Teunissen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,944

(22) PCT Filed: Oct. 2, 2006
(86) PCT No.: PCT/IB06/53583

§ 371 Date: Apr. 2, 2008

(30) Foreign Application Priority Data
Oct. 3, 2005 (EP) 05109148.6

(51) Int. Cl. G02F 1/1335

(52) U.S. Cl. 349/112

(57) ABSTRACT

An image display apparatus (100) is disclosed. The image display apparatus (100) comprises: a display device (104) for displaying an image, by emission of display light in a first direction; a scattering layer (102) disposed in front of the display device (104), for scattering a portion of the ambient light; and a reflective layer (106) disposed in between the display device (104) and the scattering layer (102) for reflecting a portion of the scattered ambient light into the first direction.

The invention relates to an image display apparatus, comprising:

a display device for displaying an image, by emission of display light in a first direction; and

a scattering layer disposed in front of the display device, for scattering a portion of the ambient light.

A major complaint with respect to especially large display apparatus is their non-aesthetic appearance when they are not in use. This hinders acceptance in consumers' homes. It is within the philosophy of some designers and interior architects to develop concepts where the display device is disguised by a static or dynamic architectural object. In other words unobtrusive design is considered to be relevant.

Ambient displays is the overall name for display apparatus that can display information in the on-state and are a decorative part of their environment in the off-state e.g. similar appearance as the wall in front of which the display apparatus is located. Typically, the display device of a display apparatus comprises light absorbing materials. The result is that the display apparatus looks like a “black hole” when it is turned off.

In order to prevent that “black hole” appearance it is proposed to provide the display apparatus with a scattering layer in front of the display device, i.e. at the viewing side of the display device. The scattering layer is arranged to scatter a portion of the ambient light which falls on the scattering layer. With ambient light is meant, light that originates from any light source which does not belong to the display apparatus. The light source may be a lamp in the room in which the display apparatus is located. Ambient light may also be sun light coming through the windows of the room in which the display apparatus is located.

With scattering is meant that light is directed in random directions. Scattering also comprises diffuse reflection. The effect of diffuse reflection is that a portion of the ambient light is directed in a forward direction, i.e. in the direction of a viewer of the display apparatus. Hence, the ambient light which falls on the display apparatus is no longer completely absorbed, because it is also partly reflected. The “black hole” appearance is substantially prevented.

Preferably, the scattering layer is in close contact with the display device in order to obtain a thin display apparatus. However, when investigating various types of materials it was found that currently commercially available scattering layers (PDLC, CTLC, polymer network LC based) do not offer sufficient hiding power to make the display device substantially invisible in its off state under the condition that the display device and the scattering layer are in relatively close contact. Depending on the type of effect and the thickness of the scattering layer the distance between the display device and scattering layer needed to be at least 4 cm.

Increasing the thickness of the scattering layer would improve the hiding power in some extend, and would result in a smaller distance between the display device and the scattering layer. However, the drawback of increasing the thickness of this scattering layer is an increase in the driving voltage. In addition the transmissive state will have a reduced transmission, and more residual haze

It is an object of the invention to provide a display apparatus of the kind described in the opening paragraph with an improved scattering of the ambient light.

This object of the invention is achieved in that the image display apparatus further comprises a reflective layer disposed in between the display device and the scattering layer for reflecting a portion of the scattered ambient light into the first direction. The reflective layer is preferably of influence for the light transmitted by the scattering layer and not for the light emitted by the display, thus not having a negative effect on the image quality and display luminance.

An additional advantage of the image display apparatus according to the invention is that the appearance of a typical scattering layer changes from grimy white to sparkling white. The grimy or greyish appearance of a typical scattering layer originates from the fact that a typical scattering layer is arranged to scatter a portion of the ambient light in a direction towards the display device and another portion back to the viewer in a wavelength-dependent manner. The addition of the reflective layer results in additional ambient light scattered back to a viewer, including scattered ambient light with wavelengths, which would not have been reflected without the reflecting layer.

In an embodiment of the image display apparatus according to the invention, the scattering layer is comprised in a scattering device further comprising electrical means for controlling the amount of scattering by the scattering layer. This embodiment of the display device according to the invention comprises a so-called active scattering layer. The amount of light scattering by the scattering layer is preferably related to a voltage difference across the scattering layer, which is created by electrodes at opposite sides of the scattering layer. Preferably the electrodes are highly transparent and may comprise indium tin oxide (ITO) but can occasionally also be indium zinc oxide (IZO) also known to those skilled in the field as a transparent electrode. Preferably the square resistance of the transparent electrodes is sufficiently low to minimize the required voltage between the two electrodes needed to switch between different states.

Preferably the scattering device is arranged to switch between a first state in which hardly any scattering of light takes place and a second state in which the scattering of light is relatively strong. Typically, the first state corresponds to the turned on state of the display device while the second state corresponds to the turned off state of the display device. Preferably, a voltage difference across the scattering layer is minimal for the first state resulting in no energy consumption during the periods in which the display device is turned off.

In another embodiment of the image display apparatus according to the invention, the scattering layer is a scattering polarizer, which is substantially transmissive for the display light having a first polarization direction and which is arranged to scatter the portion of the ambient light having a second polarization direction being orthogonal to the first direction. This embodiment of the display apparatus according to the invention comprises a so-called passive scattering layer, meaning that the amount of scattering is predetermined and cannot be controlled during operation of the display apparatus. A scattering polarizer is a material which has different behaviors for respective polarization directions. The scattering polarizer is substantially transparent for light having a first polarization direction and is arranged to scatter light having a second polarization direction which is orthogonal with the first polarization direction. An example of the scattering polarizer is described in the PhD thesis of Henri Jagt, “Polymeric polarization optics for energy efficient liquid crystal display illumination”, 2001, Chapter 2 and in patent application WO01/90637.

This scattering polarizer can be based on particles embedded in a polymer matrix. Blending small particles with a known polymer like e.g. PEN or PET followed by extrusion of this mixture to a foil and stretching this foil, makes the scattering polarizer. The stretching provides uniaxial orientation, making it transparent for the first polarization direction whereas it is scattering for the orthogonal polarization direction. In the display apparatus according to the invention the transmissive polarization direction of the scattering polarizer is chosen to be parallel to the polarization direction of the emitted display that especially works with a liquid crystal based display device that is provided with dichroic polarizers to generate the image.

In an embodiment of the image display apparatus according to the invention, the scattering layer comprises Polymer Dispersed Liquid Crystals (PDLC).

In an embodiment of the image display apparatus according to the invention, the scattering layer comprises Cholesteric Texture Liquid Crystals (CTLC).

In an embodiment of the image display apparatus according to the invention, the scattering layer comprises Liquid Crystal (LC) gels.

In an embodiment of the image display apparatus according to the invention, the scattering layer comprises polymer network Liquid Crystal (PNLC).

In an embodiment of the image display apparatus according to the invention, the reflective layer is a semi transparent mirror. Unfortunately, the transmission of the display light, i.e. the information shown on the display device will be effected. A possible remedy against this is increasing the light output of the display device.

In another embodiment of the image display apparatus according to the invention, the reflective layer is a polarizer which is substantially transparent for the display light having a first polarization direction. The reflective polarizer can be a stack of alternating birefringent and non-birefringent layers in a periodicity that enables Bragg reflection for the second polarization direction and provides transmission for the orthogonal, i.e. first polarization direction. Preferably, the transmissive state of the polarizer is chosen to be parallel to the polarization of the emitted display light which especially works with a liquid crystal based display device that is provided with dichroic polarizers to generate the image. An example of a reflective polarizer that is based on this principle is a polarizer film supplied by 3M company under the name of Vikuity™ Dual Brightness Enhancement Films (DBEF).

Another way of making reflective polarizers is based on cholesteric films as described in U.S. Pat. No. 5,506,704, U.S. Pat. No. 5,793,456, U.S. Pat. No. 5,948,831, U.S. Pat. No. 6,193,937 and in ‘Wide-band reflective polarizers from cholesteric polymer networks with a pitch gradient’, D. J Broer, J. Lub, G. N. Mol, Nature 378 (6556), 467-9 (1995). In combination with a quarter wave film this film provides the same optical function as DBEF.

Alternatively the reflective polarizer is based on the so-called wire grid principle where narrow periodic lines of a metal with a periodicity smaller than the wavelength of light are applied on a glass or plastic substrate.

Preferably, the reflective layer is a scattering polarizer, which is arranged to reflect the portion of the scattered ambient light having a second polarization direction being orthogonal to the first direction. The scattering polarizer is aligned with the display device such that display light emitted by the display device, which has the first polarization direction, is transmitted without substantial negative effect.

An embodiment of the image display apparatus according to the invention further comprises a light source located at a border of the scattering layer, the image display apparatus being arranged to emit light being generated by the light source, by means of the scattering layer. By means of the light source or preferably multiple light sources at multiple borders of the scattering layer light can be coupled into the scattering layer and/or a substrate being disposed adjacent to the scattering layer. During operation of the light source(s), the light of these light sources will be scattered by the scattering layer and eventually a portion of that light will be emitted in the first direction. The operation of the light source(s) may be simultaneously with the operation of the display device. The result is an increased user experience. Alternatively, the operation of the light source(s) takes place in the turned off state of the display device. The result is an increased amount of the light in the first direction, resulting in a further decrease of the “black hole” effect.

In an embodiment of the image display apparatus according to the invention, the scattering layer comprises a dye with a predetermined color. Preferably a dichroic dye is added to the liquid crystal material of the scattering layer. The dye color is enhanced in the scattering state and substantially hidden to a large extent in the non-scattering state. Alternatively colored polarizer filters are used to change the appearance of the display apparatus in a subtle way. That means that aesthetic properties of the image display apparatus are modified.

An embodiment of the image display apparatus according to the invention further comprises an optical absorption means disposed in front of the scattering layer, for partly absorbing ambient light. A negative effect of the reflective layer is a reduction of the image display contrast due to more reflection of ambient light. This is especially noticeable in dark scenes. By applying an absorption polarizer, as optical absorption means, in front of the scattering layer the reflection can be reduced, in particular if the absorption polarizer is arranged to absorb ambient light having the polarization direction, which would have been reflected by the reflective polarizer. It will be clear that the absorption polarizer is arranged to be transparent for light having the polarization direction of the emitted display light.

In yet another embodiment the neutral or the colored absorption polarizer is placed between the scattering layer and the reflective layer providing the same function but with a somewhat different perception of the viewer.

Preferably, the optical absorption means is electrically controllable for controlling the amount of absorption by the optical absorption means. Instead of a passive, optionally colored, absorption polarizer an active (colored) absorption polarizer e.g. based on guest-host LC may be used. The electrically controllable optical absorption means provides the possibility to modify the amount of reflection.

In practice it is not always desirable to use display devices and scattering layers of equal size. It is often sufficient, and cheaper, that only a (relatively) small part of the image display apparatus accommodates a display device. Thus the surface area occupied by the display device is smaller than the available surface area behind the scattering layer. However due to optical properties at the area of the display device being different from optical properties at the further area of the scattering layer, a smaller display device may still be recognized at the front of the scattering layer, which may be disturbing to the viewer. To overcome this, a light-shield used at the back of the scattering layer may be used preventing light, originating from sources other than the display device, from being transmitted from the back of the scattering layer towards the front. Such light-shields often also act as a mechanical support for the display device, and consists for instance of a wooden or metal plate which is e.g. coated with black velvet or black paint. Despite this approach, it is often still possible to differentiate between the area of the display device and its surroundings due to a kind of “edge effect”.

One of the embodiments according to the invention has as one of its goals to overcome the “edge effect”. To this end in that embodiment of the image display apparatus according to the invention, the reflecting layer is at least partly covered by an absorbing layer at the non-viewing side, which is direct towards the display device, the absorbing layer comprising an open area which is aligned with the display device. A further elaboration on the particular technical feature of this embodiment can be found in a patent application of the same applicant filed at the European patent office at January 15^{th}, with application number 04100107.4 (Attorney Docket number PHNL040048) (See also IB2005/050018)

It is apparent that in order to enhance the display apparatus further additional optical films and/or layers may be applied. Examples are antireflex layer e.g. based on interference or refractive index gradients, antiglare layers, e.g. based on slightly corrugated surfaces, layers that optically couple the various components by refractive index matching, etc.

These and other aspects of the image display apparatus according to the invention will become apparent from and will be elucidated with respect to the implementations and embodiments described hereinafter and with reference to the accompanying drawings, wherein:

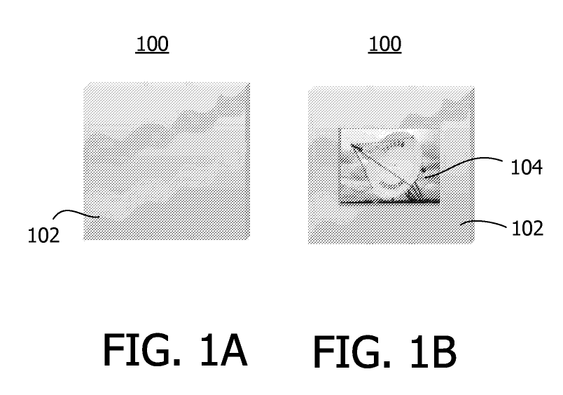

FIG. 1A shows a front view of an embodiment of the image display apparatus when the display device is turned off,

FIG. 1B shows the front view of the embodiment of the image display apparatus of FIG. 1A when the display device is turned on;

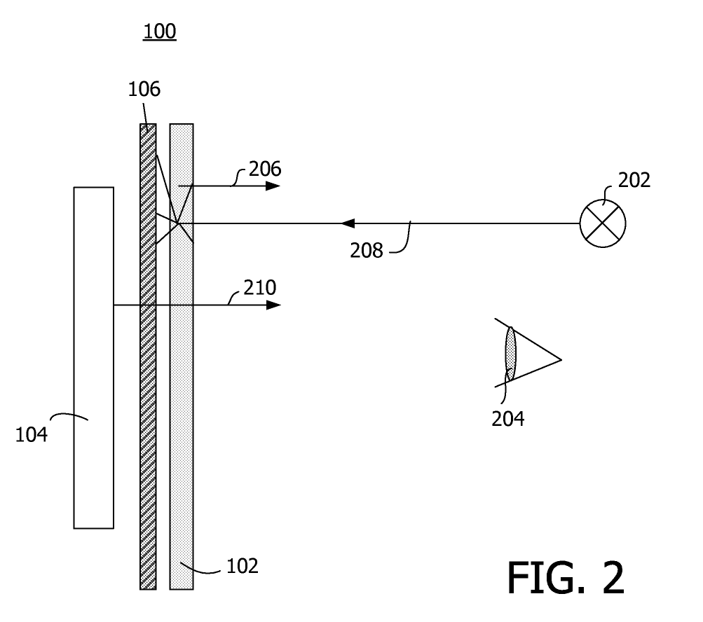

FIG. 2 schematically shows an embodiment of the display apparatus according to the invention;

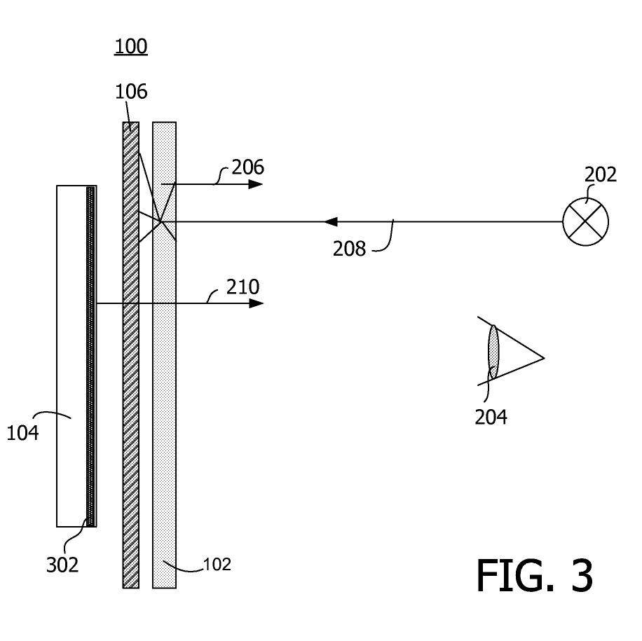

FIG. 3 schematically shows an embodiment of the display apparatus according to the invention, wherein the display device is an LCD device;

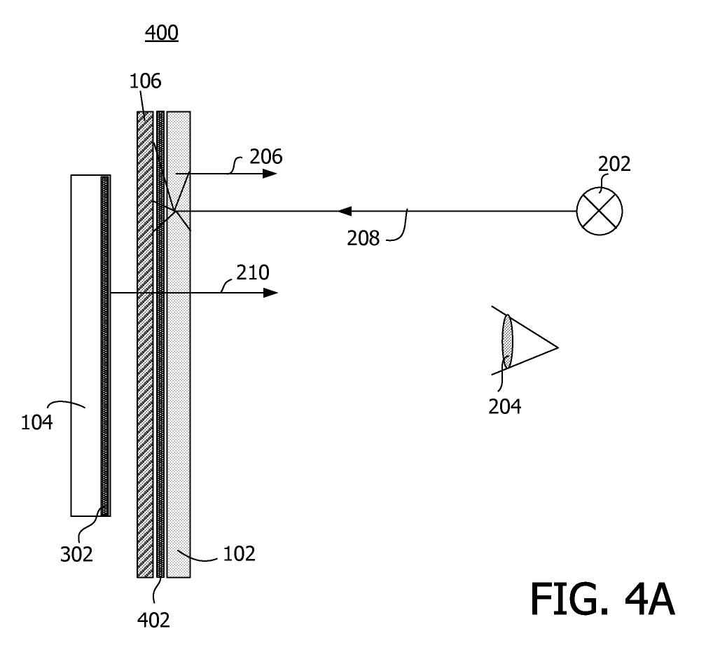

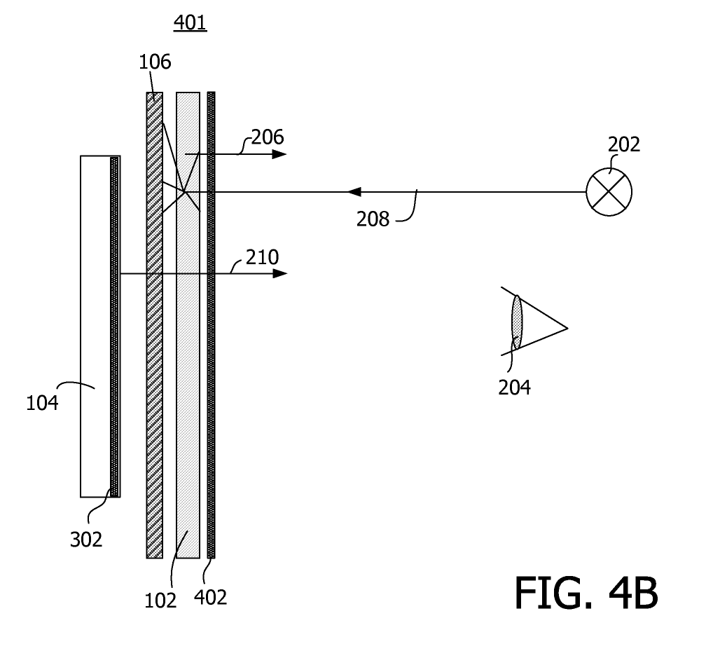

FIG. 4A schematically shows an embodiment of the display apparatus according to the invention comprising an absorption polarizer disposed between the scattering layer and the reflection layer;

FIG. 4B schematically shows an embodiment of the display apparatus according to the invention comprising an absorption polarizer disposed in front of the scattering layer;

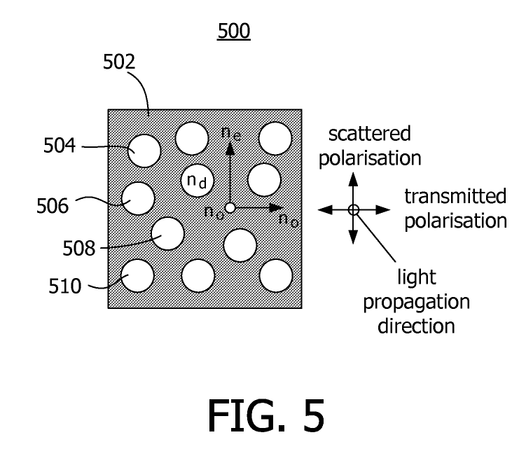

FIG. 5 schematically shows a scattering polarizer;

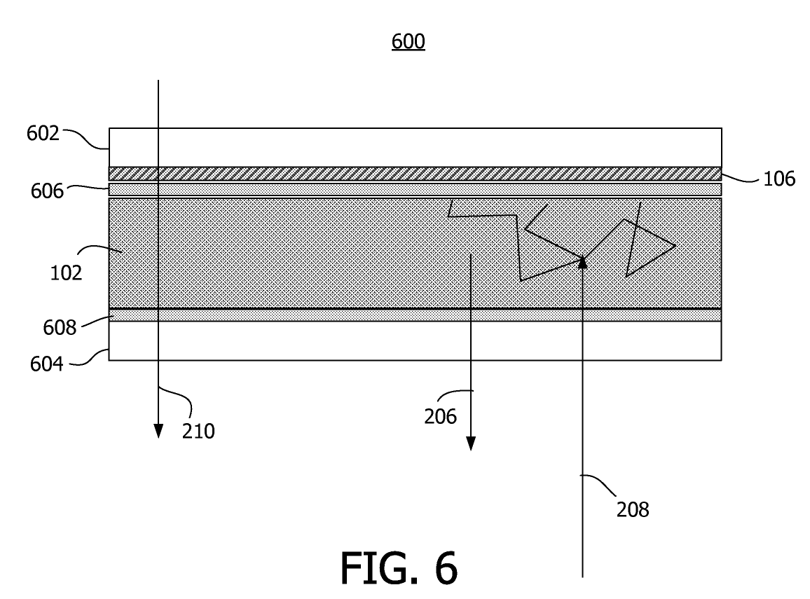

FIG. 6 schematically shows a scattering device comprising the scattering layer;

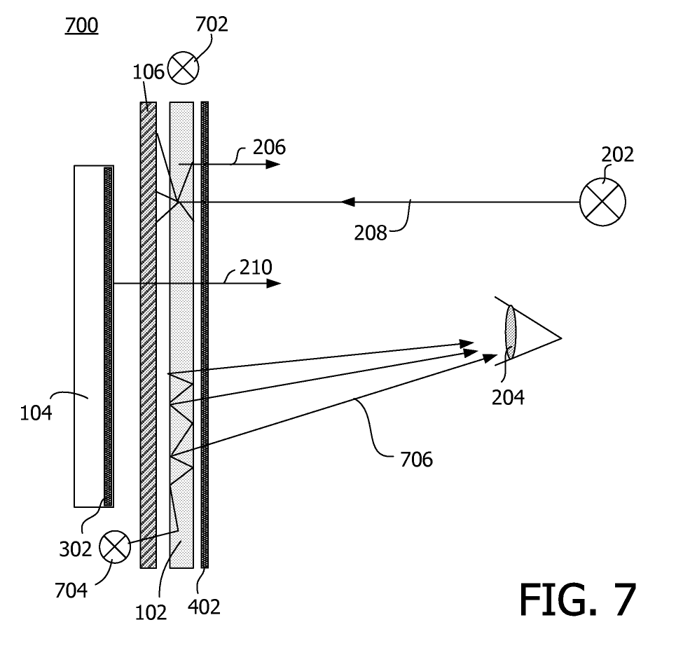

FIG. 7 schematically shows an embodiment of the display apparatus according to the invention comprising additional light sources at the borders of the scattering layer;

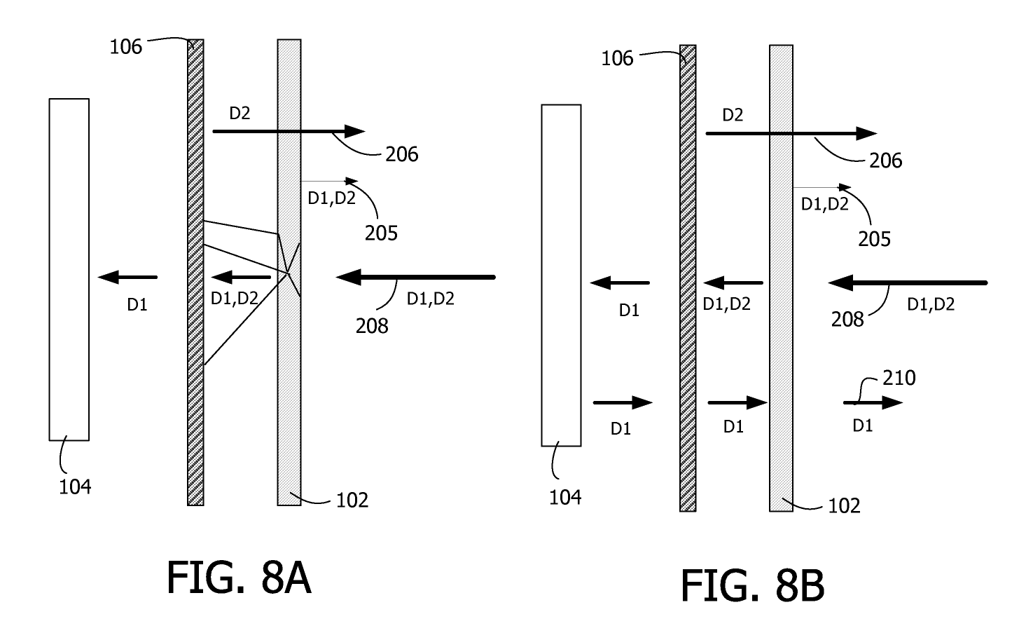

FIG. 8A schematically shows the passing of light rays in an embodiment of the display apparatus according to the invention, whereby the display device is turned off, and

FIG. 8B schematically shows the passing of light rays in the embodiment of the display apparatus according to the invention of FIG. 8A, whereby the display device is turned on.

The Figures are diagrammatic and not drawn to scale. Same reference numerals are used to denote similar parts throughout the Figures.

FIG. 1A shows a front view of an embodiment of the image display apparatus 100 when the display device 104 is turned off. Basically, a viewer 204 (See FIG. 2) sees a preferably flat surface with dimensions that are equal to the respective dimensions of the image display apparatus. The flat surface belongs to a scattering layer 102. The scattering layer 102 is arranged to randomly direct and hence reflect at least a portion of the ambient light. The display device 104, which is located behind the scattering layer 102, is substantially invisible for the viewer 204 as long as the display device 104 is turned off.

The scattering layer 102 may be homogeneous in color, i.e. may have a single color. Preferably, the scattering layer 102 has multiple colors representing a predetermined texture. That means that at a first region of the scattering layer 102 a dye with a first color is located while at a second region of the scattering layer 102 a dye with a second color is located.

FIG. 1B shows the front view of the embodiment of the image display apparatus of FIG. 1A when the display device 104 is turned on. Now the display light 210 (see FIG. 2) being emitted by the display device 104 in the first direction passes the scattering layer 102 and can be observed by the viewer 204 that is located in front of the image display apparatus 100. Preferably, the image display apparatus 100 according to the invention is arranged to reduce the amount of scattering of ambient light if the display device 104 is turned on, i.e. producing display light. However, even if the amount of scattering of ambient light is not reduced if the display device 104 is turned on, the image being rendered on the display device 104 will be clearly visible as long as the amount of emitted display light is relatively high compared to the amount of scattered and reflected ambient light.

FIG. 2 schematically shows an embodiment of the display apparatus according to the invention. The image display apparatus 100, comprises:

a display device 104 for displaying an image, by emission of display light 210 in a first direction;

a scattering layer 102 disposed in front of the display device 104, for scattering a portion of the ambient light 208; and

a reflective layer 106 disposed in between the display device 104 and the scattering layer 102 for reflecting a portion of the scattered ambient light 206 into the first direction.

The viewer 204 is provided with:

light which originates from the display device 104, so-called display light 210, and which moves in the first direction towards the viewer 204; and/or light which originates from an ambient light source 202 (direct and/or indirect) and which is scattered by the scattering layer 102 and optionally reflected by the reflection layer 106. The light which originates from the ambient light source 202 is called ambient light 208. The scattered and reflected portion of the ambient light 208 which moves in the first direction towards the viewer is called scattered ambient light 206.

Preferably, the viewer is only provided with display light 210 if the display device 104 is turned on, i.e. is active. To realize that the scattering layer 102 is comprised in a scattering device 600 (see FIG. 6) which is arranged to limit the amount of scattered ambient light 206 under predetermined conditions. Alternatively, the scattering layer 102 is passive.

FIG. 3 schematically shows an embodiment of the display apparatus according to the invention as described in connection with FIG. 2, wherein the display device 104 is an LCD device. Although, the display apparatus according to the invention may comprise any type of display device 104, some of the technical features of the invention perfectly match with characteristics of an LCD device. In connection with the figures it is disclosed that several types of polarizers are applied. With a polarizer is meant an optical element which filters a light ray depending on the polarization directions of the respective components of the light ray. Typically, a polarizer is substantially transmissive for components of the light ray having a first polarization direction D1 (see FIG. 8) while the polarizer is substantially influencing components of the light ray having a second polarization direction D2, which is orthogonal with the first polarization direction D1. Influencing in this context comprises scattering and absorbing.

Suppose that the LCD device of the display device 104 according to the invention comprises a polarizer 302 which is arranged to be substantially transmissive for light having the first polarization direction D1. Then the various polarizers which are applied in the different embodiments of the display apparatus according to the invention are preferably aligned with the polarizer 302 of the display device 104 such that the emitted display light can pass the various polarizers without any substantial effect. However, the components of the ambient light 208 and the scattered ambient light 206 having the second polarization direction D2 will be substantially effected by the various polarizers. The various polarizers may be used for the following functions:

in an embodiment of the display apparatus according to the invention a polarizer is used as scattering layer 102;

in an embodiment of the display apparatus according to the invention a polarizer is used as reflecting layer 106; and

in an embodiment of the display apparatus according to the invention a polarizer is used as optical absorption means 402.

FIG. 4A schematically shows an embodiment of the display apparatus 400 according to the invention comprising an absorption polarizer 402 disposed between the scattering layer 102 and the reflection layer 106. The absorption polarizer 402 is arranged to absorb a portion of the scattered ambient light 206. More precisely, the absorption polarizer 402 is arranged to absorb the components of the ambient light having the second polarization direction D2. The reason is as follows.

A negative effect of the reflective layer 106 is a reduction of the image display contrast due to more reflection of ambient light 208. In other words, because of the scattering and reflection of ambient light by the display apparatus of the invention, the viewer 204 receives not only the display light 210 but also reflected ambient light. This is especially noticeable in dark scenes of the video content, i.e. when the amount of emitted display light 210 is relatively low. By applying an absorption polarizer 402, as optical absorption means 402, in front of the reflection layer 106 the reflection can be reduced. To achieve the required effect, the absorption polarizer 402 is arranged to absorb the components of the scattered ambient light 206 having the polarization direction D2 which would have been reflected by the reflective layer 106. Preferably, the reflective layer 106 is also based on a polarizer.

FIG. 4B schematically shows an embodiment of the display apparatus 401 according to the invention comprising an absorption polarizer 402 disposed in front of the scattering layer 102. This embodiment of the display apparatus 401 is substantially equal to the embodiment of the display apparatus 400 as described in connection with FIG. 4A. The difference is the position of the absorption polarizer 402.

Preferably, the absorption polarizer 402 as described in connection with FIG. 4A and FIG. 4B is a switchable absorption polarizer. The function and position of the switchable absorption polarizer corresponds to what is disclosed in patent application WO03/079318 as filed by the same applicant.

FIG. 5 schematically shows a scattering polarizer 500. A scattering polarizer 500 is a material which has different behaviors for respective polarization directions. The scattering polarizer is substantially transparent for light having a first polarization direction D1 and is arranged to scatter light having a second polarization direction D2 which is orthogonal with the first polarization direction D1. An example of the scattering polarizer is described in the PhD thesis of Henri Jagt, “Polymeric polarization optics for energy efficient liquid crystal display illumination”, 2001, Chapter 2 and in patent application WO01/90637.

A scattering polarizer 500 can be based on particles 504-510 embedded in a polymer matrix 502. Blending small particles 504-510 with a known polymer 502 like e.g. PEN or PET, followed by extrusion of this mixture to a foil and stretching this foil, makes the scattering polarizer 500. The stretching provides uniaxial orientation, making it transparent for the first polarization direction D1 whereas it is scattering for the orthogonal second polarization direction D2.

The principle of the scattering polarizer 500 is as follows. The small particles 504-510, depicted as white circles, correspond to a dispersed phase with reflective index n_{d} in a uniaxialy oriented polymer matrix 502 with a first polymer reflective index nₒ for light having a first polarization direction D1 and a second polymer reflective index nₑ for light having a second polarization direction D2. The refractive index n_{d} of the particles 504-510 is matched to the first polymer refractive index nₒ, whereas the second polymer refractive index nₑ>>n_{d}.

The scattering polarizer 500 may be based on small particles embedded in a non-colored stretched foil. The particles may be e.g. core-shell particles (Rohm and Haas, Paraloid EXL 3647) having a diameter of 200 nm and consisting of a styrene-butadiene (S-BR) rubbery core and a poly(methylmethacrylate) (PMMA) shell. In order to add color, a dye or pigment can be added either to the particles 504-510 or to the polymer matrix 502. When the dye is added to the polymer matrix 502 also a dichroic dye can be selected that orient itself with the aligned polymer matrix 502 such that especially the polarization parallel to the stretching direction becomes colored, but the scattering polarizer 500 remains transmissive for first polarization direction D1.

Rather than using spherical particles the particles might have also other shapes, for instance elongated. In one embodiment the particles have a fiber-like shape obtained by melting and elongation of the initially spherical particles during the stretching process of the polymer matrix material.

As explained above a scattering polarizer 500 may be applied as scattering layer 102 or as reflecting layer 106. Optionally, an embodiment of the display apparatus according to the invention comprises a single scattering polarizer 500 which both fulfils the scattering and reflection function, i.e. the scattering layer 102 and the reflecting layer 106 are both realized by a single scattering polarizer 500.

FIG. 6 schematically shows a scattering device 600 comprising a scattering layer 102. A scattering device 600 is arranged to control the amount of scattering of light by the scattering layer 102. The scattering device 600 comprises:

a set of substantially flat substrates 602-604, e.g. based on glass, PMMA or some other substantially transparent material;

a set of electrical conductors 606-608 adjacent to the respective substrates 602-604 acting as electrodes for applying a voltage difference. The electrical conductors are substantially transparent and preferably based on ITO; and

a scattering layer 102 being sandwiched by the set of electrical conductors 606-608.

The scattering layer 102 preferably comprises Polymer Dispersed Liquid Crystals (PDLC), Cholesteric Texture Liquid Crystals (CTLC), Liquid Crystal (LC) gels or polymer network Liquid Crystal (PNLC). By applying the appropriate voltage difference on the electrical conductors 606-608, i.e. across the scattering layer 102 the orientation of the liquid crystals can be modified, resulting in an increase or decrease of the amount of light scattering by the scattering layer 102.

To indicate the function of the scattering device 600 in the display apparatus according to the invention the direction of the display light 210, the direction of the ambient light 208 and the direction of the scattered ambient light 206 are depicted.

It is preferred that the distance between the reflecting layer 106 and the scattering layer 102 is as small as possible. The scattering device 600 as depicted in FIG. 6 comprises the reflecting layer 106. This is a so-called in-cell configuration. The reflecting layer 106 could be the electrode (as in wire grids). It should be noted that the reflecting layer 106 is optional for the scattering device 600. That means that a scattering device not including the reflecting layer 106 but being adjacent to the reflecting layer 106 could also be applied in an embodiment of the display device according to the invention. To fulfill the requirements of having a relatively small distance between reflective layer 106 and the scattering layer 102 and the reflective layer 106 being not included in the scattering device, the substrate 602 which is adjacent to the reflective layer 106 must be relatively thin. Preferably, a reflective index matching fluid, i.e. glue is applied to realize the optical contact between the reflective layer 106 and the scattering device 600.

In order to switch the scattering layer 102 partially, e.g. over a surface area with dimensions equal to those of the display device 104 behind it or equal to only a portion of that, the substrates 602-604 of the scattering device 600 may contain patterned electrodes. The patterned electrodes can be use to open and close the display area in a discrete way. But it may also be used to open the display area only partially or to apply a gradient in hiding power such that the image of the display device 104 is revealed in an aesthetic way.

Optionally, the scattering device 600 is arranged to open a portion of the display area, i.e. make a portion of scattering layer 102 substantially transparent, which corresponds to an aspect ratio which differs from the aspect ratio of the display device 104.

Preferably, the scattering device 600 is configured to make only a first portion of the scattering layer 102 substantially transparent at a first moment of time, the first portion having dimensions which substantially correspond a first image being displayed on the display device 104 at the first moment of time, the first image having a first aspect ratio and the scattering device 600 is configured to make only a second portion of the scattering layer 102 substantially transparent at a second moment of time, the second portion having dimensions which substantially correspond a second image being displayed on the display device 104 at the second moment of time, the second image having a second aspect ratio.

FIG. 7 schematically shows an embodiment of the display apparatus 700 according to the invention comprising additional light sources 702-704 at the borders of the scattering layer 102. The word “additional” is used to distinguish from the display device 104, which also comprises a light source. This embodiment of the display apparatus 700 according to the invention is arranged to emit light being generated by the light additional light sources 702-704 by means of the scattering layer 102. That means that light from the additional light sources 702-704 is coupled into the scattering layer 102, scattered by the scattering layer 102 and subsequently emitted at several locations at the surface of the scattering layer 102. A portion of that light 706 will be emitted in the first direction, i.e. towards the viewer 204.

The operation of the light sources 702-704 may be simultaneously with the operation of the display device 104. The result is an increased user experience if the control of the light is based on the video content, which is displayed at display device 104. For instance flashlights may be visualized by means of the additional light sources 702-704. Preferably, the scattering device 600 is also controlled in dependence of the video content, which is displayed at the display device 104.

Alternatively, the operation of the light sources takes place in the turned off state of the display device. The result is an increased amount of the light in the first direction, resulting in a further decrease of the “black hole” effect.

In FIG. 7 two additional light sources 702-704 are depicted, being located at respective borders of the scattering layer 102. A first one of the additional light sources 704 is located behind the scattering layer 102, while a second one of the additional light sources 702 is located more distal.

Preferably, multiple light sources 702-704 being arranged to generate light with mutually different colors are used.

FIG. 8A schematically shows the passing of light rays in an embodiment of the display apparatus according to the invention, whereby the display device 102 is turned off. The display device 102 is an LCD device. The scattering layer 102 is part of an active scattering device, which is put in state of maximum scattering. The scattering layer 106 is a reflective polarizer. In FIG. 8A is depicted that ambient light 208 which has first components having the first polarization direction D1 and second components having the second polarization direction D2 moves towards the scattering layer 102. A relatively small first portion 205 of the ambient light will be directly scattered back. (e.g. 15%) Both first components and second components will be comprised in that relatively small portion 205. A second portion of the ambient light is scattered towards the display device 104. From that second portion the light having the first polarization direction D1 passes the reflection layer 106 and is absorbed by the LCD device, while the light 206 having the second polarization direction D2 is reflected back.

FIG. 8B schematically shows the passing of light rays in the embodiment of the display apparatus according to the invention as described in connection with FIG. 8A, whereby the display device is turned on. The amount of scattered ambient light 205 and reflected scattered ambient light 206 is much lower now. FIG. 8B clearly shows that the display light 210 emitted by the display device, having the first polarization direction D1 can pass the reflection layer 106 and the scattering layer 102 without any substantial effect.

The image display apparatus according to the invention may be a television or monitor. The image display apparatus may be used by consumers at home. Alternatively the image display apparatus is applied in a vehicle or at a public location like a shop or an office.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware or software. The usage of the words first, second and third, etcetera do not indicate any ordering. These words are to be interpreted as names.

1. An image display apparatus (100), comprising:
a display device (104) for displaying an image, by emission of display light in a first direction;
a scattering layer (102) disposed in front of the display device (104), for scattering a portion of the ambient light; and
a reflective layer (106) disposed in between the display device (104) and the scattering layer (102) for reflecting a portion of the scattered ambient light into the first direction.

2. An image display apparatus as claimed in claim 1, wherein the scattering layer (102) is comprised in a scattering device (600) further comprising electrical means for controlling the amount of scattering by the scattering layer (102).

3. An image display apparatus as claimed in claim 1, wherein the scattering layer (102) is a scattering polarizer (500), which is substantially transmissive for the display light having a first polarization direction (D1) and which is arranged to scatter the portion of the ambient light having a second polarization direction (D2) being orthogonal to the first direction.

4. An image display apparatus as claimed in claim 1, wherein the scattering layer (102) comprises Polymer Dispersed Liquid Crystals (PDLC).

5. An image display apparatus as claimed in claim 1, wherein the scattering layer (102) comprises Cholesteric Texture Liquid Crystals (CTLC).

6. An image display apparatus as claimed in claim 1, wherein the scattering layer (102) comprises Liquid Crystal (LC) gels or polymer network Liquid Crystal (PNLC).

7. An image display apparatus as claimed in claim 1, wherein the reflective layer (106) is a semi transparent mirror.

8. An image display apparatus as claimed in claim 1, wherein the reflective layer (106) is a polarizer which is substantially transparent for the display light having a first polarization direction (D1).

9. An image display apparatus as claimed in claim 8, wherein the reflective layer (106) is a scattering polarizer (500) which is arranged to reflect the portion of the scattered ambient light having a second polarization direction (D2) being orthogonal to the first direction.

10. An image display apparatus as claimed in claim 1, further comprising a light source located at a border of the scattering layer (102), the image display apparatus being arranged to emit light being generated by the light source, by means of the scattering layer (102).

11. An image display apparatus as claimed in claim 1, wherein the scattering layer (102) comprises a dye with a predetermined color.

12. An image display apparatus as claimed in claim 1, further comprising an optical absorption means disposed in front of the scattering layer (102), for partly absorbing ambient light.

13. An image display apparatus as claimed in claim 12, wherein the optical absorption means is electrically controllable for controlling the amount of absorption of the optical absorption means.

14. An image display apparatus as claimed in claim 1, further comprising an optical absorption means disposed in between the reflective layer (106) and the scattering layer (102), for partly absorbing ambient light.

15. An image display apparatus as claimed in claim 1, whereby the reflecting layer is at least partly covered by an absorbing layer at the non-viewing side which is direct towards the display device (104), the absorbing layer comprising an open area which is aligned with the display device (104).

16. An image display apparatus as claimed in claim 1, comprising the scattering device (600), whereby the scattering device 600 is configured to make:
only a first portion of the scattering layer (102) substantially transparent at a first moment of time, the first portion having dimensions which substantially correspond the respective dimensions of the image being displayed on the display device (104) at the first moment of time; and
to make only a second portion of the scattering layer (102) substantially transparent at a second moment of time, the second portion having dimensions which substantially correspond the respective dimensions of a second image being displayed on the display device (104) at the second moment of time.

17. An image display apparatus as claimed in claim 16, whereby the first portion has a first aspect ratio and the second portion has a second aspect ratio being different from the first aspect ratio.
